(19) United States
(12) Patent Application Publication
(10) Pub. No.: US 2021/0358025 A1
(43) Pub. Date: Nov. 18, 2021

(54) VEHICLE SHARING SYSTEMS AND METHODS FOR MATCHING AVAILABLE VEHICLES TO USER REQUESTS

(71) Applicant: TOYOTA MOTOR ENGINEERING & MANUFACTURING NORTH AMERICA, INC., Plano, TX (US)

(72) Inventors: Darin Rosekrans, South Lyon, MI (US); Mahmoud ElAhdan, Canton, MI (US); Derek Lewis, Monroe, MI (US)

(73) Assignee: TOYOTA MOTOR ENGINEERING & MANUFACTURING NORTH AMERICA, INC., PLANO, TX (US)

(21) Appl. No.: 16/875,334

(22) Filed: May 15, 2020

(51) Int. Cl. G06Q 30/06; G08G 1/00; G07C 5/02; G07C 5/00; G06Q 10/02

(52) U.S. Cl. CPC G06Q 30/0645; G08G 1/205; G06Q 10/02; G07C 5/02; G07C 5/008; G08G 1/202

(57) ABSTRACT

Vehicle sharing systems and methods for permitting vehicles to be used by requesting users when available and facilitating payment transactions between the owners of the vehicles and the requesting users are provided. The vehicle includes one or more processors and one or more memory modules. The one or more memory modules include a computer-readable medium storing computer-readable instructions that, when executed by the one or more processors, cause the one or more processors to identify when the vehicle is not in use, create a vehicle availability schedule identifying when the vehicle is available based on when the vehicle is not in use, upload the vehicle availability schedule to a server, and receive instruction from the server to permit the vehicle to be used by a user when authorized by an owner of the vehicle

### TECHNICAL FIELD

The present specification generally relates to ride sharing systems and methods for permitting vehicles to be used by a requesting user when available and, more specifically, ride sharing systems and methods for facilitating payment transactions between the owners of the vehicles and the requesting users.

### BACKGROUND

Currently, many individuals collect primary or secondary incomes by driving ride sharing vehicles. However, this requires the individuals to operate their vehicles, which may prevent them from being able to work other jobs for additional income. As it may be difficult to coordinate schedules between multiple part-time jobs, individuals oftentimes tend to drive ride sharing vehicles full time.

These vehicles may be owned by the individuals or rented on an as-needed basis. When the vehicles are owned by the individuals, there are times, and sometimes days, in which the vehicle remains unused such as, for example, during evenings and weekends. During these times, the vehicle could potentially be used for ride or vehicle sharing purposes, but instead serves no purpose if not driven by the owner.

### SUMMARY

In one embodiment, a vehicle includes one or more processors and one or more memory modules. The one or more memory modules include a computer-readable medium storing computer-readable instructions that, when executed by the one or more processors, cause the one or more processors to identify when the vehicle is not in use, create a vehicle availability schedule identifying when the vehicle is available based on when the vehicle is not in use, upload the vehicle availability schedule to a server, and receive instruction from the server to permit the vehicle to be used by a user when authorized by an owner of the vehicle.

In another embodiment, a vehicle sharing system includes a server, one or more processors, and one or more memory modules. The server includes a listing of vehicles, parameters associated with each vehicle, and owner information of each vehicle. The one or more memory modules includes a computer-readable medium storing computer-readable instructions that, when executed by the one or more processors, cause the one or more processors to receive a request from a user, match a vehicle in the listing of vehicles to the request, send a notification to an owner of the matched vehicle to authorize the request, and send a signal to the matched vehicle to permit the vehicle to be used by the user.

In yet another embodiment, a method for providing vehicle sharing services includes identifying when a vehicle is not in use, creating a vehicle availability schedule identifying when the vehicle is available based on when the vehicle is not in use, receiving a request from a user to deploy a vehicle, matching the request from the user to the vehicle when the vehicle is available, sending a notification to an owner of the vehicle to authorize the request, and permitting the vehicle to be used by the user when the request is authorized by the owner of the vehicle.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a vehicle sharing system according to one or more embodiments shown and described herein;

FIG. 2 schematically depicts a server of the vehicle sharing system according to one or more embodiments shown and described herein; and

FIG. 3 schematically depicts a flow diagram of the vehicle sharing system according to one or more embodiments shown and described herein.

### DETAILED DESCRIPTION

Embodiments described herein are directed to vehicle sharing systems and methods for permitting vehicles to be used by a requesting user when available and facilitating payment transactions between the owners of the vehicles and the requesting users. The vehicle sharing system includes a database including a listing of vehicles, parameters associated with each vehicle, and owner information of each vehicle. Upon receiving a request from a user, the request is matched to one of the vehicles in the database and a notification is sent to the owner of the matched vehicle to authorize the request. If the request is authorized, then the matched vehicle is permitted to be used by the user. The vehicle may be automatically deployed to the user, if the vehicle is an autonomous vehicle or, alternatively, a notification may be sent to the user with instructions on how to retrieve the vehicle.

It is to be appreciated that the present disclosure allows for vehicles that are available to be requested by a user and used for vehicle sharing services. It should be appreciated that, although the present disclosure has particular utility for serving personal needs, the owner of the vehicle may be a business seeking to utilize a plurality of underutilized fleet vehicles. Similarly, the user may be a business requiring one or more available vehicles to be used for delivery purposes such as, for example, a grocery store, furniture company, or other business providing delivery services. Further, the vehicle sharing system allows for a payment transaction to be facilitated between the requesting user and the vehicle owner based on the user's use of the vehicle including, for example, duration and distance traveled. Thus, the ride sharing systems and methods disclosed herein permit vehicle owners to receive additional income for allowing their vehicle to be used by others when available.

Various embodiments of the vehicle sharing systems and methods for permitting vehicles to be used for vehicle sharing services and the operation of the vehicle sharing systems and methods are described in more detail herein. Whenever possible, the same reference numerals will be used throughout the drawings to refer to the same or like parts.

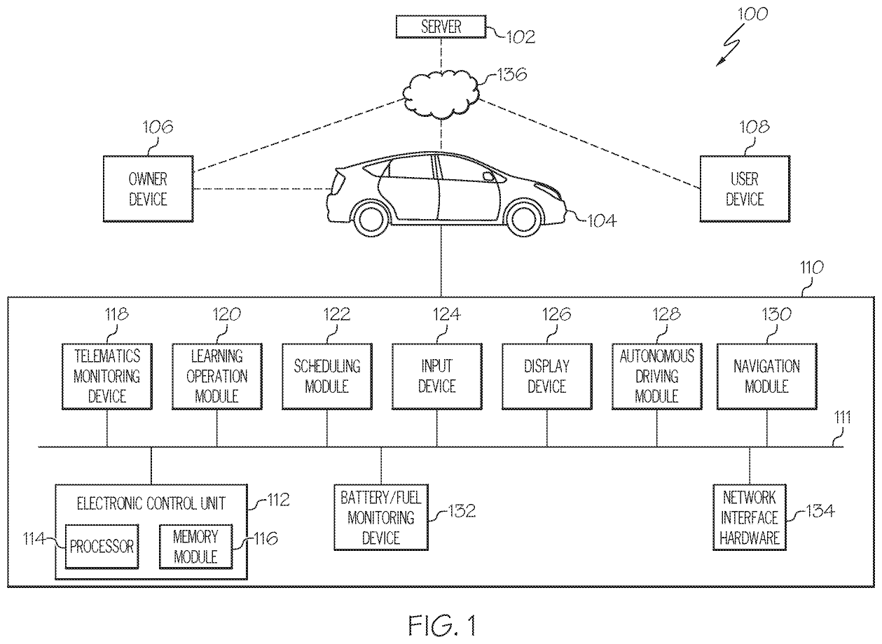

Referring now to FIG. 1, a vehicle sharing system 100 is illustrated according to one or more embodiments described herein. The vehicle sharing system 100 may generally include a server 102, a vehicle 104 communicating with the server 102, an owner device 106 associated with an owner of the vehicle 104, and a user device 108 that communicates with the server 102.

As shown in FIG. 1, example components of a non-limiting embodiment of the vehicle 104 including an onboard computing device 110 are schematically depicted. In some embodiments, the onboard computing device 110 includes a communication path 111, an electronic control unit 112 including a processor 114 and a memory module 116, a telematics monitoring device 113, a learning operation module 120, a scheduling module 122, an input device 124, a display device 126, an autonomous driving module 128, a navigation module 130, a battery/fuel monitoring device 132, and network interface hardware 134. The various components of the vehicle 104 and the interaction thereof will be described in detail below.

The communication path 111 may be formed from any medium that is capable of transmitting a signal such as, for example, conductive wires, conductive traces, optical waveguides, or the like. Moreover, the communication path 111 may be formed from a combination of mediums capable of transmitting signals. In one embodiment, the communication path 111 comprises a combination of conductive traces, conductive wires, connectors, and buses that cooperate to permit the transmission of electrical data signals to components such as processors, memories, sensors, input devices, output devices, and communication devices. Accordingly, the communication path 111 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 111 communicatively couples the various components of the vehicle 104. As used herein, the term “communicatively coupled” means that coupled components are capable of exchanging data signals with one another such as, for example, electrical signals via conductive medium, electromagnetic signals via air, optical signals via optical waveguides, and the like.

The processor 114 of the electronic control unit 112 of the vehicle 104 may be any device capable of executing machine-readable instructions. Accordingly, the processor 114 may be a controller, an integrated circuit, a microchip, a computer, or any other computing device. The processor 114 may be communicatively coupled to the other components of the vehicle 104 by the communication path 111. Accordingly, the communication path 111 may communicatively couple any number of processors with one another, and allow the components coupled to the communication path 111 to operate in a distributed computing environment. Specifically, each of the components may operate as a node that may send and/or receive data. While the embodiment depicted in FIG. 1 includes a single processor 114, other embodiments may include more than one processor.

The memory module 116 of the electronic control unit 112 of the vehicle 104 is coupled to the communication path 111 and communicatively coupled to the processor 114. The memory module 116 may, for example, contain instructions to detect when the vehicle 104 is in use based on the telematics monitoring device 113. In this example, these instructions stored in the memory module 116, when executed by the processor 114, may allow for the determination that the vehicle 104 is in use or idle, and for how long the vehicle 104 has being either in use or idle. The memory module 116 may comprise RAM, ROM, flash memories, hard drives, or any non-transitory memory device capable of storing machine-readable instructions such that the machine-readable instructions can be accessed and executed by the processor 114. The machine-readable instructions may comprise logic or algorithm(s) written in any programming language of any generation (e.g., 1GL, 2GL, 3GL, 4GL, or 5GL) such as, for example, machine language that may be directly executed by the processor 114, or assembly language, object-oriented programming (OOP), scripting languages, microcode, etc., that may be compiled or assembled into machine-readable instructions and stored in the memory module 116. Alternatively, the machine-readable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 1 includes a single memory module 116, other embodiments may include more than one memory module.

The telematics monitoring device 113 of the vehicle 104 is coupled to the communication path 111 and communicatively coupled to the processor 114. The telematics monitoring device 113 collects vehicle usage data of the vehicle 104 by detecting, for example, vehicle on and vehicle off operations. As non-limiting examples, the telematics monitoring device 113 detects when the vehicle 104 is turned on, when the vehicle is turned off, locations at which the vehicle 104 was turned on and off, how long the vehicle 104 was turned on for, and how long the vehicle was turned off for. For purposes described in more detail herein, the telematics monitoring device 113 also detects how far the vehicle 104 was driven during a specified period of time, such as when it is driven or used by the user.

The learning operation module 120 of the vehicle 104 is coupled to the communication path 111 and communicatively coupled to the processor 114 and the telematics monitoring device 113. The learning operation module 120 collects vehicle usage data identified by the telematics monitoring device 113 discussed herein and uses a machine learning algorithm for identifying patterns and trends so as to predict when the vehicle 104 will be in use, i.e., unavailable, and when the vehicle 104 will not be in use, i.e., available. As used herein, the term “unavailable” refers to the vehicle 104 not being capable of being selected for vehicle sharing services by the vehicle sharing system 100. Alternatively, the term “available”, as used herein, refers to the vehicle 104 being capable of being selected for vehicle sharing services by the vehicle sharing system 100. Specifically, the learning operation module 120 takes into consideration days and times at which the vehicle 104 is either in use or not in use to determine these patterns. Over time, and with increased use of the vehicle, the learning operation module 120 becomes more accurate in determining these patterns and trends as to when the vehicle 104 may be available. A non-limiting example may be the learning operation module 120 identifying that the vehicle 104 is not in use, and thus available, between the hours of 9:00 am to 5:00 pm Monday through Friday based on the fact that it is determined that the vehicle 104 is driven to a work destination and not utilized during these hours of the day.

The scheduling module 122 of the vehicle 104 is coupled to the communication path 111 and communicatively coupled to the processor 114 and the learning operation module 120. The scheduling module 122 utilizes learned data provided by the learning operation module 120 to create a vehicle availability schedule identifying when the vehicle 104 is available, i.e., not in use. The vehicle availability schedule identifies when the vehicle 104 is available for vehicle sharing services and for how long the vehicle 104 is available. Specifically, the vehicle availability schedule identifies which days and times the vehicle is available and, in some embodiments, which days and times the vehicle 104 is unavailable. In some instances, the scheduling module 122 communicates with the owner device 106 via the network interface hardware 134 to receive additional availability data useful for creating or improving the vehicle availability schedule. For example, the scheduling module 122 may communicate with the owner device 106 to collect data on events the owner plans on attending and may require the vehicle 104 by communicating with a calendar application or email application on the owner device 106. This information may be used to adjust the vehicle availability schedule for individual days and times that may not be consistent with the available days and times determined by the learning operation module 120. In addition, the vehicle availability schedule may be reviewed by the owner for accuracy and manually modified via the owner device 106, the input device 124 of the vehicle 104, or any other suitable device with access to the vehicle availability schedule.

The input device 124 of the vehicle 104 is coupled to the communication path 111 and communicatively coupled to the processor 114 and, as noted above, to the scheduling module 122 for manually adjusting the vehicle availability schedule. The input device 124 may be any device capable of transforming physical contact into a data signal that can be transmitted over the communication path 111 such as, for example, a button, a switch, a knob, a microphone or the like. In some embodiments, the input device 124 includes a power button, a volume button, an activation button, a scroll button, or the like. The input device 124 may be provided so that the owner, or the user, may interact with the vehicle 104 such as to navigate menus, make selections, set preferences, and other functionality described herein.

The display device 126 is coupled to the communication path 111 and communicatively coupled to the processor 114. The display device 126 may include any medium capable of transmitting an optical output such as, for example, a cathode ray tube, light emitting diodes, a liquid crystal display, a plasma display, or the like. Moreover, the display device 126 may be a touchscreen that, in addition to providing optical information, detects the presence and location of a tactile input upon a surface of or adjacent to the display device 126. Accordingly, the display device 126 may include the input device 124 and receive mechanical input directly from the input device 124. The display device 126 may be provided on a dashboard of the vehicle 104 or any other suitable location that may be visible to the owner or the user when seated in the driver's seat of the vehicle 104.

When the vehicle 104 is an autonomous vehicle, the autonomous driving module 128 is coupled to the communication path 111 and communicatively coupled to the processor 114. The autonomous driving module 128 is configured to provide autonomous driving capabilities to the vehicle 104 such as, for example, starting the vehicle 104, driving the vehicle 104 to a predetermined location, driving the vehicle 104 to a destination, and driving the vehicle 104 back to an starting location. Although not shown, it is to be understood that the autonomous driving module 128 may include or be communicatively coupled to external cameras, sensors, and the like for detecting objects exterior of the vehicle 104 and navigating the vehicle 104 accordingly.

In some embodiments, the navigation module 130 is coupled to the communication path 111 and communicatively coupled to the processor 114, the autonomous driving module 128, and the display device 126. The navigation module 130 receives location information and/or destination information provided in the request from the user. When the vehicle 104 is an autonomous vehicle, the navigation module 130 communicates with the autonomous driving module 128 to provide navigation instructions for directing or autonomously navigating the vehicle 104 to the location of the user and back to the initial location of the vehicle 104. The navigation module 130 also communicates with the autonomous driving module 128 to provide navigation instructions for directing or autonomously navigating the vehicle 104 to the destination as provided in the request from the user. In some embodiments, the navigation module 130 may provide navigation instructions on the display device 126 of the vehicle 104 for displaying the destination information and/or other location information while in route.

The battery/fuel monitoring device 132 is coupled to the communication path 111 and communicatively coupled to the processor 114. The battery/fuel monitoring device 132 is configured to monitor a battery/fuel level of the vehicle 104 to determine a max run time. As used herein, the term “max run time” refers to an estimated time in which the vehicle 104 may be operated before running out of battery, in the case of an electric vehicle, or fuel, in the case of a motorized vehicle. In determining the max run time, the battery/fuel monitoring device 132 takes into account both the time in which the vehicle 104 may be operated and an estimated distance in which the vehicle 104 can travel before running out of battery or fuel. As discussed in more detail herein, when the max run time of the vehicle 104 is below a threshold determined by the request of the user, the vehicle 104 may be deemed unavailable for purposes of being used in the vehicle sharing system 100.

The network interface hardware 134 is coupled to the communication path 111 and communicatively coupled to the processor 114. The network interface hardware 134 may be any device capable of transmitting and/or receiving data via a network. Accordingly, network interface hardware 134 can include a wireless communication module configured as a communication transceiver for sending and/or receiving any wired or wireless communication. For example, the network interface hardware 134 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, network interface hardware 134 includes hardware configured to operate in accordance with the Bluetooth wireless communication protocol. In another embodiment, network interface hardware 134 may include a Bluetooth send/receive module for sending and receiving Bluetooth communications to/from a portable electronic device, such as a key fob or a mobile computing device, for example, the owner device 106 or the user device 108. The network interface hardware 134 may also include a radio frequency identification (“RFID”) reader configured to interrogate and read RFID tags. Thus, as described in more detail herein, the network interface hardware 134 permits the user, once authorized, to access the vehicle 104 and operate the vehicle 104 for the duration of the trip upon the network interface hardware 134 confirming the identification of the user device 108.

In some embodiments, the vehicle 104 may be communicatively coupled to a portable electronic device, such as the owner device 106 and the user device 108, directly via the network interface hardware 134 or indirectly via a network 136. In addition, the vehicle may be communicatively coupled to the server 102 via the network 136. In some embodiments, the network 136 is a personal area network that utilizes Bluetooth technology to communicatively couple the vehicle 104 to the owner device 106 and the user device 108. In other embodiments, the network 136 may include one or more computer networks (e.g., a local area network, or a wide area network), cellular networks, satellite networks and/or a global positioning system and combinations thereof. Accordingly, the vehicle 104 can be communicatively coupled to the network 136 via a wide area network, via a local area network, via a personal area network, via a cellular network, via a satellite network, or the like. Suitable local area networks may include wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable cellular networks include, but are not limited to, technologies such as LTE, WiMAX, UMTS, CDMA, and GSM.

As stated above, the network 136 may be utilized to communicatively couple the vehicle 104 with the owner device 106 and the user device 108. The owner device 106 and the user device 108 may each include a mobile phone, a smartphone, a personal digital assistant, a camera, a dedicated mobile media player, a mobile personal computer, a laptop computer, and/or any other portable electronic device capable of being communicatively coupled with the vehicle 104. As such, the owner device 106 and the user device 108 may include one or more processors and one or more memory modules. The one or more processors can execute logic to communicate with the vehicle 104.

As noted above, the server 102 may be communicatively coupled to the vehicle 104 via the network 136. The server 102 may also be communicatively coupled to the owner device 106 for accessing, adding, and modifying vehicle parameters and owner preferences, discussed in more detail herein, and communicatively coupled to the user device 108 for receiving a request from the user device 108 requesting a vehicle.

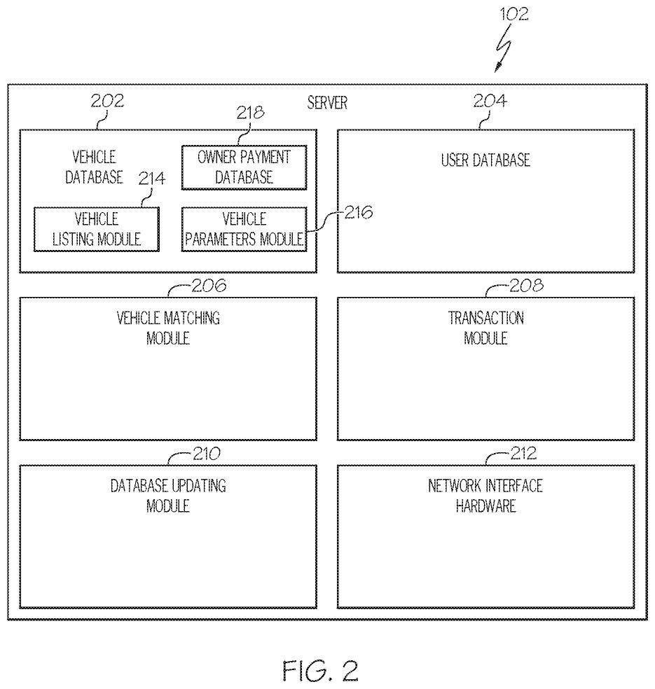

As shown in FIG. 2, the server 102 is schematically shown. The server 102 includes a vehicle database 202, a user database 204, a vehicle matching module 206, a transaction module 208, a database updating module 210, and network interface hardware 212.

The network interface hardware 212 of the server 102 communicatively couples the vehicle database 202, the user database 204, the vehicle matching module 206, the transaction module 208, and the database updating module 210 to the network 136. Further, the network interface hardware 212 communicatively couples the server 102 to the vehicle 104 via the network interface hardware 134 of the vehicle 104, as well as to the owner device 106 and the user device 108. As such, the network interface hardware 212 may be any device capable of transmitting and/or receiving data via the network 136. Accordingly, the network interface hardware 212 can include a wireless communication module configured as a communication transceiver for sending and/or receiving any wired or wireless communication. As described in more detail herein, the network interface hardware 212 receives a request from a user via the user device 108 requesting access to a vehicle in the vehicle database 202, sends a notification to an owner via the owner device 106 detailing the request from the user, and receives an authorization from the owner of the vehicle to accept the request. In some embodiments, the network interface hardware 212 sends a notification to the user device 108 with instructions on how to access the vehicle.

The vehicle database 202 includes a vehicle listing module 214, a vehicle parameters module 216, and an owner payment database 218. The vehicle listing module 214 includes a listing of all vehicles registered in the vehicle sharing system 100. For example, an owner of a vehicle may register his or her vehicle to be included in the vehicle listing module 214 via the owner device 106 or any other suitable computing device in which the server 102 may be accessed. In registering the vehicle 104 in the vehicle listing module 214, the vehicle registration may include connection information for communicating with the network interface hardware 134 of the vehicle 104 so that the server 102 may be able to send information to and retrieve information from the vehicle 104 such as, for example, the navigation module 130, battery/fuel monitoring device 132. By including the vehicle 104 in the vehicle listing module 214, the vehicle may be identified as a matched vehicle available to the user, as described in more detail herein. The vehicle registration may also include other vehicle identifying information such as, for example, VIN number, license plate number, etc.

Upon the owner listing the vehicle 104 in the vehicle listing module 214, the vehicle availability schedule determined by the scheduling module 122 may be retrieved from the vehicle 104 or the owner device 106, or uploaded to the vehicle parameters module 216. In addition to the vehicle availability schedule being uploaded to the vehicle parameters module 216, the vehicle parameters module 216 includes parameters of the vehicle such as, for example, vehicle type (autonomous, electric, manual, etc.), number of seats, color, location, max run time, and owner preferences. The owner preferences may include factors determining which users may be permitted to match with the vehicle 104 such as, for example, starting or pick-up location, destination, duration of vehicle usage, age of user, etc.

When the owner of the vehicle 104 registers the vehicle 104 with the vehicle listing module 214, or at some point thereafter, the owner is prompted to enter payment information, which is stored in the owner payment database 218. The server 102 may request payment information pertaining to how the owner wishes to receive payment for permitting the vehicle 104 to be used in the vehicle sharing system 100 when matched. For example, the owner payment database 218 may store bank account number for a checking account or a savings account, a debit card number, or other payment information such as login credentials for a third-party transaction service such as, for example, PayPal, Apple Pay, Venmo, or the like.

It should be appreciated that although the vehicle identifying information, the vehicle parameters, and the owner payment information may be stored in separate databases, listings, or modules, the vehicle 104 in the vehicle listing module 214 is linked to associated parameters stored in the vehicle parameters module 216 and associated owner payment information stored in the owner payment database 218. Similarly, when the vehicle listing module 214 includes a plurality of vehicles of different owners, each vehicle in the vehicle listing module 214 is linked to associated parameters in the vehicle parameters module 216 and associated owner payment information in the owner payment database 218 particular to the owner of that vehicle.

The user database 204 includes a listing of users that are registered with the vehicle sharing system 100. Users may register with the vehicle sharing system 100 using any suitable computing device, such as the user device 108, by including user identifying information, such as the user's name, driver's license number, phone number, address, user payment information, and the like. The user may also include general user requirements or preferences used to determine which vehicle the user should be matched with. Examples of user preferences may include vehicle type (autonomous, electric, manual, etc.), number of seats, vehicle color, starting location, and the like. It should be appreciated that these preferences are stored are applied to every request from the user. However, a request from the user may include additional preferences specific to that request.

The vehicle matching module 206 of the server 102 is communicatively coupled to the vehicle database 202 and the user database 204 such that, when the network interface hardware 212 of the server 102 receives a request from a user, the request is sent to the vehicle matching module 206, which assigns or otherwise matches an available vehicle from the vehicle listing module 214 with the request. In matching a vehicle to the request, the vehicle matching module 206 takes into consideration the associated owner preferences, the parameters of the vehicles stored in the vehicle parameters module 216, including the max run time, and the user preferences. The vehicle matching module 206 identifies a vehicle ranking the highest in terms of most suitable for the owner and the user as the matched vehicle and the vehicle matching module 206 instructs the network interface hardware 212 to send a notification to the owner device 106 of the matched vehicle to authorize the request. The notification sent to the owner of the matched vehicle may include identifying information of the user and details of the request including, for example, duration of vehicle usage, destination, and other user identifying information.

The database updating module 210 is responsible for updating the availability of the vehicles listed in the vehicle listing module 214. While the vehicle listing module 214 may be manually modified by the owners of the vehicles to permanently or temporarily make the vehicle unavailable, the database updating module 210 collects vehicle specific information, such as an updated vehicle availability schedule, from the vehicles and updates the vehicle database 202 accordingly. Further, the database updating module 210 is configured to regularly update the vehicle listing module 214 in real-time based on which vehicles in the vehicle listing module 214 have been requested and authorized to temporarily indicate that those vehicles are unavailable to prevent the vehicles from being selected for further requests. Additionally, once the server 102 recognizes that a vehicle has been returned by the user, the database updating module 210 updates the vehicle listing module 214 to indicate that the vehicle is once again available.

The transaction module 208 of the server 102 is configured to facilitate a transaction or transfer of payment from an authorized user to an owner of an accessed vehicle. In some embodiments, the transaction module 208 retrieves payment information of both the owner and the user from the owner payment database 218 and the user database 204, respectively, and carries out the transaction directly or indirectly using a third-party transaction service. In some embodiments, the transaction module 208 may communicate directly or indirectly with a third-party transaction service such as, for example, PayPal, Apple Pay, Venmo, or the like for carrying out the transaction. In some embodiments, the owner and/or the user is informed as to an estimated cost of the user accessing the vehicle in advance. The transaction module 208 may determine the estimated cost based on the type of vehicle, time of day, distance to be traveled, demand, and other various factors. Once the vehicle is returned, a final cost is determined, the funds are withdrawn from the user's specified source of payment and provided to the owner of the vehicle.

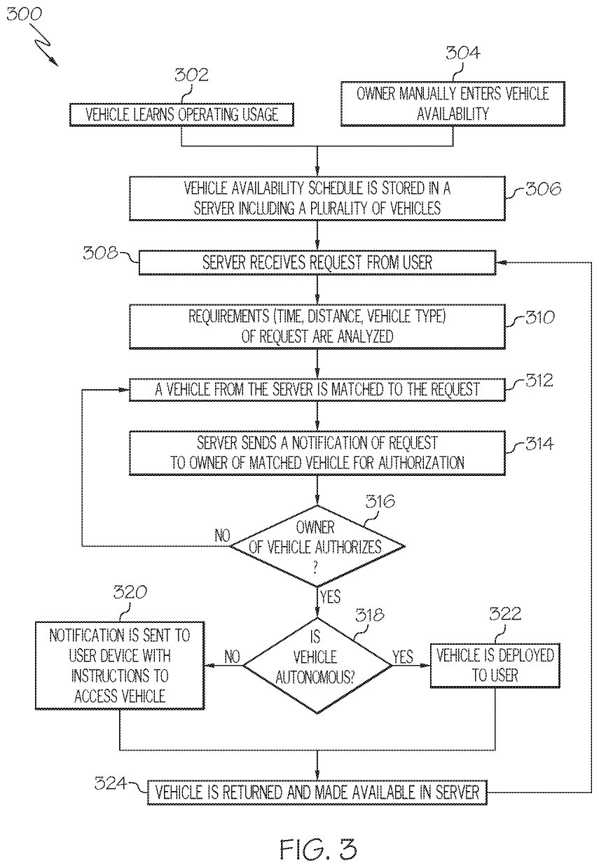

Referring now to FIG. 3, an illustrative method 300 of utilizing the vehicle sharing system 100 is shown in which a request from a user is received and matched to a vehicle, with reference to FIGS. 1 and 2. Initially, the vehicle 104, specifically the scheduling module 122, creates the vehicle availability schedule to determine when the vehicle 104 is available and able to be requested and, further, when the vehicle 104 is unavailable and not able to be requested. In some embodiments, at block 302, operating usage of the vehicle 104 is learned by the telematics monitoring device 113 detecting vehicle usage data. The vehicle usage data is then sent to the learning operation module 120, which, using the machine learning algorithm, determines trends and patterns of when the vehicle 104 is available and when the vehicle 104 is unavailable. This data is then sent to the scheduling module 122 to compile the vehicle availability schedule, which identifies days and times when the vehicle 104 is available and, in some embodiments, when the vehicle is unavailable. In creating the vehicle availability schedule, the scheduling module 122 may communicate directly, or indirectly through the network interface hardware 212 of the server 102, with the owner device 106 to identify additional days and times that the vehicle 104 may be unavailable based on events saved in the owner device 106 such as, for example, events in a calendar application or an email application of the owner device 106.

In some embodiments, the vehicle 104 may not be equipped to learn the availability of the vehicle 104. Thus, at block 304, the owner of the vehicle 104 may manually enter vehicle availability data to create the vehicle availability schedule as opposed to requiring that the vehicle 104 to use machine learning to determine its availability. In some embodiments, the owner may enter or modify the vehicle availability data on the input device 124 of the vehicle 104 or using the owner device 106. It should be appreciated that the vehicle learning performed at block 302 and the owner manually entering vehicle availability at block 304 are not exclusive of one another and may be carried out simultaneously or asynchronously to improve the accuracy of the vehicle availability schedule.

At block 306, the vehicle availability schedule is uploaded to the server 102, specifically the vehicle listing module 214 of the vehicle database 202, from the vehicle 104 via the network interface hardware 134. In some embodiments, when manually creating the vehicle availability schedule, the vehicle availability schedule may be uploaded to the server 102 via the owner device 106 or another suitable electronic computing device with access to the server 102. As discussed herein, the vehicle listing module 214 maintains an updated listing of the vehicles and their associated vehicle availability schedules. Thus, when the vehicle 104 is determined to be available, the vehicle 104 is able to matched to a request. Alternatively, when the vehicle 104 is determined to be unavailable, based on its associated vehicle availability schedule, the vehicle 104 is not matched to a request. In some embodiments, the owner of the vehicle 104 may have the option to override to allow for requests to be received when the vehicle availability schedule determines that the vehicle 104 is unavailable and the vehicle 104 is not currently being used by another user through the vehicle sharing system 100.

At block 308, the server 102 receives a request from the user. Specifically, the user, using the user device 108, sends a request to the server 102 requesting access to a vehicle. The request may be sent by any suitable means such as, for example, email or through a downloadable software application installed onto the user device 108 communicating with the server 102. The request sent from the user device 108 includes requirements or parameters for the desired usage of a vehicle including, for example, vehicle type, starting location, destination(s), duration of vehicle usage, etc.

At block 310, the requirements identified in the request are analyzed by the vehicle matching module 206 to identify which vehicles from the vehicle database 202 satisfy these requirements. Specifically, a vehicle will be prevented from being identified as one of the identified vehicles satisfying the requirements of the request if, for example, the max run time of the vehicle determined by the battery/fuel monitoring device 132 is below a threshold. The threshold is determined by calculating the distance to be traveled based on, for example, the starting location and the destination(s), and the duration of vehicle usage, as provided in the request, as well as, in some embodiments, traffic and other factors. In some embodiments, there may be an option to override such that a vehicle having a max run time below the threshold may still be requested only if the user confirms that he or she will fill the vehicle with gas or charge the vehicle.

At block 312, the vehicles that satisfy the requirements provided in the request may be ranked by the vehicle matching module 206 according to which vehicle has parameters that most coincide with the requirements provided in the request. Ranking the qualifying vehicles may include analyzing the parameters of the vehicles with the requirements in the request. For example, one qualifying vehicle may be ranked higher or lower than another qualifying vehicle if the owner preferences stored within the vehicle parameters module 216, as discussed above, restrict usage of the vehicle only to specified destinations or usage during periods of time. Thereafter, the highest ranking vehicle may be identified as the matched vehicle.

At block 314, the server 102, specifically the network interface hardware 212, sends a notification to the owner device 106 of the matched vehicle indicating that the vehicle 104 has been requested. The notification requests authorization via the owner device 106 to permit the user to access the vehicle 104. In some embodiments, the notification may include details of the request, as well as user identifying information of the user that sent the request.

After reviewing the notification, the owner of the vehicle 104 makes a determination at block 318 as to whether to authorize or deny the request. If the owner of the vehicle 104 chooses to deny the request at block 316, then, at block 320, the process returns to block 312 and another vehicle from the list of qualifying vehicles that satisfy the requirements of the request is selected as the matched vehicle. Thus, the process repeats at block 314 by sending a notification to the owner device 106 of the newly matched vehicle.

However, if the owner of the originally matched vehicle 104 determines at block 316 to authorize the request, the process proceeds to block 318. Once the request is authorized at block 316, the database updating module 210 updates the vehicle listing module 202 to identify that the vehicle 104 is unavailable. Thereafter, it may be determined at block 318 whether or not the vehicle 104 is an autonomous vehicle. This may be automatically determined based on the information provided in the vehicle database 202 of the server 102 or a response may be requested by the owner based on whether or not the owner wishes to permit autonomous driving capabilities to the user.

If it is determined that the vehicle 104 is not an autonomous vehicle, or currently not utilizing autonomous driving capabilities, at block 318, then, at block 320, a notification is sent to the user device 108 with instructions on how to access the vehicle 104. The instructions may include when and where to pick up the vehicle 104, and how to enter the vehicle 104. When the user arrives at the vehicle 104, the network interface hardware 134 of the vehicle 104 may verify the identity of the user using any suitable means such as, for example, recognizing the presence of the user device 108 via Bluetooth or other near field communication protocols, and/or scanning the user device 108 once within the vehicle 104 to initiate a vehicle start and permit the vehicle 104 to be driven.

If it is determined that the vehicle 104 is an autonomous vehicle and utilizing autonomous driving capabilities at block 318, then, at block 322, the vehicle 104 may be automatically deployed to the user at the starting location specified in the request. The user device 108 may be sent a notification when to expect the vehicle 104. Similar to that discussed above, when the vehicle 104 arrives at the starting location, the network interface hardware 212 of the vehicle 104 may verify the identity of the user using any suitable means such as, for example, recognizing the presence of the user device 108 via Bluetooth or other near field communication protocols, and/or scanning the user device 108 once within the vehicle 104 to permit the vehicle 104 to be driven.

While using the vehicle 104, the destination provided in the request may be automatically sent to the navigation module 130 of the vehicle 104 and displayed on the display device 126. If necessary, the user may make any adjustments, such as to the destination, via the input device 124 of the vehicle 104 or by using the user device 108 in communication with the server 102.

At block 324, once the user is done with the vehicle 104, the user may be directed to return the vehicle 104 to a specified location either by a notification sent to the user device 108 or displayed on the display device 126 of the vehicle 104 if the vehicle is not an autonomous vehicle. The specified location may be the location at which the user picked up the vehicle 104 or the starting location at which the vehicle 104 picked up the user. If the vehicle 104 is an autonomous vehicle, the vehicle 104 may the proceed to return to the starting location. In some embodiments, if the vehicle 104 is an autonomous vehicle, the vehicle 104 may return itself to a different location to pick up another user, for example, if the owner authorized another request.

Upon completion of the user using the vehicle 104, the transaction is carried out by the transaction module 208 such that the funds for using the vehicle 104 are withdrawn from the user payment account, as identified in the user database 204, and deposited into the owner payment account, as identified in the owner payment database 218 of the server 102. As discussed herein, the cost of the vehicle usage may be estimated at the outset based on the details of the request, but are calculated after the vehicle is returned to determine actual vehicle usage, including the distance traveled and the duration of vehicle usage.

If the vehicle 104 is returned without any pending requests to be authorized by the owner, the database updating module 210 updates the vehicle listing module 202 to identify that the vehicle 104 is once again available. Thus, the process returns to block 308 while the vehicle 104 is available and awaits another request to be received by the network interface hardware 212 of the server 102.

From the above, it is to be appreciated that defined herein is a vehicle sharing system configured to match a request from a user desiring to obtain access to an available, ride sharing vehicle, and a vehicle capable of identifying a vehicle availability schedule to permit the vehicle to be matched to the request such that an owner of the vehicle may be able to receive payment while the vehicle is not being utilized.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
one or more processors; and
one or more memory modules comprising a computer-readable medium storing computer-readable instructions that, when executed by the one or more processors, cause the one or more processors to:
identify when the vehicle is not in use;
create a vehicle availability schedule identifying when the vehicle is available based on when the vehicle is not in use;
upload the vehicle availability schedule to a server; and
receive instruction from the server to permit the vehicle to be used by a user when authorized by an owner of the vehicle.

2. The vehicle of claim 1, wherein the vehicle is an autonomous vehicle including an autonomous driving module configured to drive the vehicle to a starting location of the user.

3. The vehicle of claim 1, further comprising a navigation module, the navigation module configured to receive destination information and direct the vehicle to a destination.

4. The vehicle of claim 1, further comprising network interface hardware, the network interface hardware configured to communicate with a user device of the user to permit access to the vehicle upon identifying the user device.

5. The vehicle of claim 1, further comprising a telematics monitoring device, the telematics monitoring device configured to monitor at least one of when the vehicle is turned on, when the vehicle is turned off, locations at which the vehicle is turned on, locations at which the vehicle is turned off, how long the vehicle is turned on, and how long the vehicle is turned off.

6. The vehicle of claim 1, further comprising a battery/fuel monitoring device, the battery/fuel monitoring device configured to determine a max run time of the vehicle.

7. The vehicle of claim 6, wherein the battery/fuel monitoring device prevents the vehicle from being used by the user when the max run time of the vehicle is below a threshold based on a request from the user.

8. The vehicle of claim 7, wherein the request includes at least one of a duration of vehicle usage, a starting location, and a destination.

9. The vehicle of claim 1, further comprising an input device, the input device configured to receive input from the owner to modify the vehicle availability schedule.

10. A vehicle sharing system comprising:
a server including a listing of vehicles, parameters associated with each vehicle, and owner information associated with each vehicle;
one or more processors; and
one or more memory modules comprising a computer-readable medium storing computer-readable instructions that, when executed by the one or more processors, cause the one or more processors to:
receive a request from a user;
match a vehicle in the listing of vehicles to the request;
send a notification to an owner of the matched vehicle to authorize the request; and
send a signal to the matched vehicle to permit the matched vehicle to be used by the user.

11. The vehicle sharing system of claim 10, further comprising a transaction module for receiving a payment from the user based on a usage of the matched vehicle.

12. The vehicle sharing system of claim 11, wherein the transaction module is configured to send the received payment to the owner of the matched vehicle.

13. The vehicle sharing system of claim 11, further comprising a database updating module configured to update the listing of vehicles based on which vehicles are not currently available.

14. A method for providing vehicle sharing services comprising:
identifying when a vehicle is not in use;
creating a vehicle availability schedule identifying when the vehicle is available based on when the vehicle is not in use;
receiving a request from a user to deploy the vehicle;
matching the request from the user to the vehicle when the vehicle is available;
sending a notification to an owner of the vehicle to authorize the request; and
permitting the vehicle to be used by the user when the request is authorized by the owner of the vehicle.

15. The method of claim 14, further comprising:
receiving a payment from the user based on a usage of the vehicle; and
sending the payment to the owner of the vehicle.

16. The method of claim 14, wherein the vehicle is autonomously driven to a starting location of the user after the request is authorized by the owner.

17. The method of claim 14, wherein a notification is sent to the user with instructions for accessing the vehicle.

18. The method of claim 14, wherein the vehicle is prevented from being accessed by the user if a battery or fuel level of the vehicle is below a threshold, the threshold determined based on the request from the user.

19. The method of claim 14, further comprising:
indicating that the vehicle is not available when it is authorized to be accessed by the user;
updating a listing of vehicles to identify that the vehicle is not available; and
updating the listing of vehicles to reflect that the vehicle is available when the vehicle is returned.

20. The method of claim 15, wherein matching the request from the user to the vehicle is based on requirements in the request from the user, the requirements including at least one of a duration of vehicle usage, a distance to be traveled, and a vehicle type.
